(19) United States
(12) Patent Application Publication
(10) Pub. No.: US 2014/0214490 A1
(43) Pub. Date: Jul. 31, 2014

(54) SLIDER BASED PRICING USING MULTIPLE DATA POINTS

(71) Applicant: HEWLETT-PACKARD DEVELOPMENT COMPANY, L.P., Houston, TX (US)

(72) Inventors: Shyam Shankar Menon, Bangalore (IN); Prabir Kumar Guswamee, Bangalore (IN); Matthew Russell Tollestrup, Salt Lake City, UT (US)

(73) Assignee: HEWLETT-PACKARD DEVELOPMENT COMPANY, L.P., Houson, TX (US)

(21) Appl. No.: 13/754,591

(22) Filed: Jan. 30, 2013

(51) Int. Cl. G06Q 30/02

(52) U.S. Cl. CPC G06Q 30/0206
USPC 705/7.35; 705/7.11

(57) ABSTRACT

Techniques pertaining to automatically pricing a service involving multiple data points are disclosed. A server including a processing component hosts and manages an application. The application may receive multiple data points from a client computer device over a network connection, the multiple data points comprising pricing proposal data for a service to be provided. Multiple pricing points may be determined including a base cost pricing point. The base cost pricing point may be calculated from the multiple data points and indicative of the minimum cost to provide the service. The application may create an interactive graphical representation of the multiple pricing points. Thereafter, the application may receive input from the client computer device indicative of a target cost savings and calculate a target savings pricing point.

### BACKGROUND

Determining pricing for products and services often requires the seller to consider multiple data points. Successful pricing may reflect a price in which the customer realizes a cost savings over what the seller's competitors are offering but greater than the cost of delivering the service or manufacturing cost of the product. There may also be instances when the salesperson may need authorization from higher management to be able to make a particular proposal to the customer. However, the multiple data points used by the seller may necessitate a good understanding of the actual data to achieve optimal pricing. Such an understanding may not be fully possessed by an individual salesperson.

### BRIEF DESCRIPTION OF THE DRAWINGS

FIG. 1 illustrates an example of a system architecture for a pricing application according to an embodiment of the disclosure.

FIG. 2 illustrates another example of a system architecture for a pricing application according to an embodiment of the disclosure.

FIG. 3 illustrates an example of a messaging diagram according to an embodiment of the disclosure.

FIG. 4 illustrates an example embodiment of a logic flow.

FIG. 5 illustrates an example embodiment of a logic flow.

FIG. 6 illustrates an example embodiment of a logic flow.

FIG. 7 illustrates an example embodiment of a logic flow.

FIG. 8 illustrates an example of a pricing slider application screenshot according to an embodiment of the disclosure.

### DETAILED DESCRIPTION

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Determining customized pricing for products and services may require a seller to consider multiple data points. However, the multiple data points that should be used by the seller may not be fully understood by an individual salesperson. The data points may be complex and even variable. Some data points may require an understanding of different economic factors that are not typically within the expertise of a salesperson.

For example, channel managed print services may involve managing various printers that are under contract where the ink needs and the service needs for a customer may be sold through channel partners. Sales of channel managed print services operate under a contractual basis rather than a transactional basis. A transactional basis is simple to administer as it merely involves pricing equipment and supplies for outright purchase. The consumer is responsible for managing the use of the equipment and supplies on their own. The contractual basis, on the other hand, is more comprehensive as it considers the idea of leasing equipment (e.g., printers), delivering supplies (e.g., ink/toner), and maintenance of the equipment through a single contract. In this model, the consumer is paying for a service as opposed to a product. The contractual service is more encompassing than that of the transactional purchase. The pricing of such a channel managed print services contract must consider multiple data points. These data points may further have to consider factors such as equipment depreciation, ink efficiency, number of pages (sometimes referred to as impressions), cost of service calls, reliability of the equipment, etc. when structuring the price of a channel managed print services contract. Sales people do not typically have a great understanding of how to price these multiple data points quickly and efficiently but still need an easy way to price a contract taking into consideration the multiple costs.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

Embodiments herein allow a computer implemented system to price a contract based on various cost indicators while also allowing a user (e.g., salesperson) to move a slider associated with a graphical interface of the computer implemented system to a desired position to reach a targeted savings. Such an approach may be used in various situations where the salesperson evaluates pricing a proposal based on multiple factors such as cost incurred, cost of buying the product from the open market, current customer cost etc. Such a system allows salespersons doing the pricing to specify a target savings based on various cost indicators and the price being automatically calculated based on it without the salesperson needing to have a significant understanding into the underlying cost indicators.

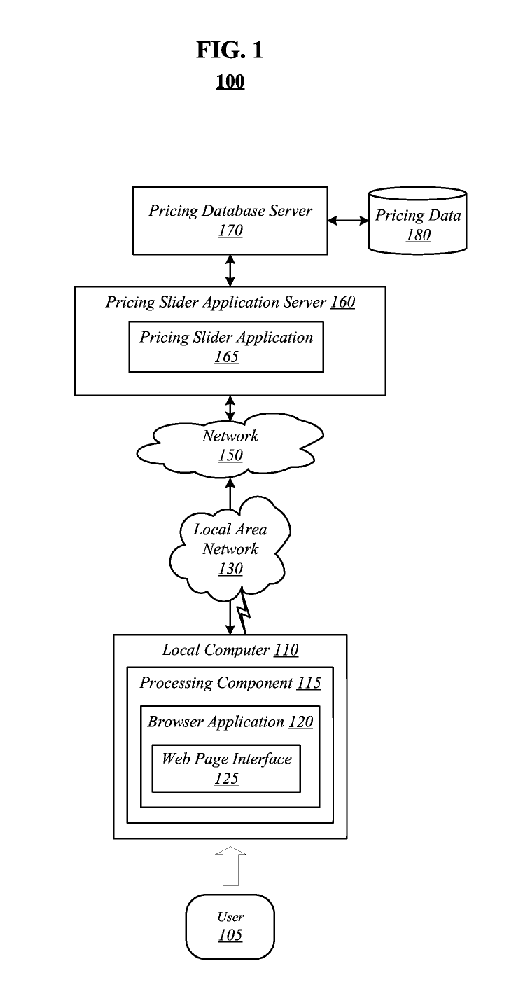

FIG. 1 illustrates an example of a system architecture 100 for a pricing application according to an embodiment of the disclosure. The system architecture 100 may be implemented using a client server model. A local computer (e.g., client) 110 may include a processing component 115. A browser application 120 executing on the local computer 110 under control of the processing component 115 may permit a user 105 to view web sites and web pages hosted on remote web servers. In this instance, a web page interface 125 may be associated with a pricing slider application 165 hosted by a pricing slider application server 160. The local computer 110 may be coupled to the pricing slider application server 160 over one or more networks and network connections. For instance, the local computer 110 may be coupled with a local area network (LAN) 130. The LAN 130 may, in turn, be coupled with a broader network 150 such as, for instance, the Internet or a wide area network (WAN) functioning as a corporate intra-net.

The local computer 110 may be coupled directly (e.g., wired) with the LAN 130 or may be coupled wirelessly over an 802.11 or Bluetooth type connection giving the user 105 a degree of mobility when using the system.

The pricing slider application server 160 and the pricing slider application 165 it hosts may have access to a pricing database server 170 and, in turn, to a pricing database 180. The pricing slider application 165 may be represented on the user's 105 local computer 110 via the web page interface 125 of browser application 120. That is, the user 105 may browse to the pricing slider application 165 and have data for an interface to the pricing slider application 165 downloaded over the network 150 and LAN 130 such that the user 105 may see a graphical representation and interact with the pricing slider application 165. The user 105 may enter and the pricing slider application 165 may receive requests and input data pertaining to a pricing proposal. Some of the requests from the user 105 via local computer 110 may trigger the pricing slider application server 160 to request pricing data from the pricing database server 170 and pricing database 180 as well as cause the pricing database server 170 to make calculations using the requested pricing data.

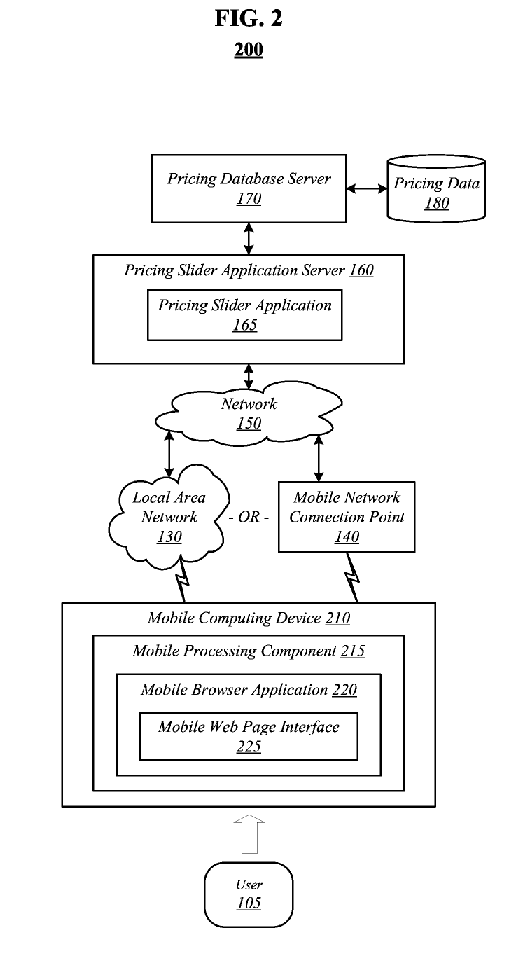

FIG. 2 illustrates another example of a system architecture 200 for a pricing application according to an embodiment of the disclosure. The embodiment of FIG. 2 is similar to that of FIG. 1 but characterizes the “client” computer as a portable mobile computing device 210. The portable mobile computing device 210 may comprise, for example, a smartphone or tablet computer. The portable mobile computing device 210 may include a processing component 215. A browser application 220 executing on the portable mobile computing device 210 under control of the processing component 215 may permit a user 105 to view web sites and web pages hosted on remote web servers. In this instance, a web page interface 225 may be associated with a pricing slider application 165 hosted by a pricing slider application server 160. The portable mobile computing device 210 may be coupled to the pricing slider application server 160 over one or more networks and network connections. For instance, the portable mobile computing device 210 may be coupled with a local area network (LAN) 130. The LAN 130 may, in turn, be coupled with a broader network 150 such as, for instance, the Internet. In another example, the portable mobile computing device 200 may be wirelessly coupled to a mobile network connection point 140 using cellular radio frequency (RF) technology. The mobile network connection point 140, in turn, may be coupled with network 150 to provide access to the pricing slider application server 160 and the pricing slider application 165. This mobile aspect of connectivity may allow user(s) 105 to access and use the system anywhere a mobile network connection can be made with a mobile network connection point 140.

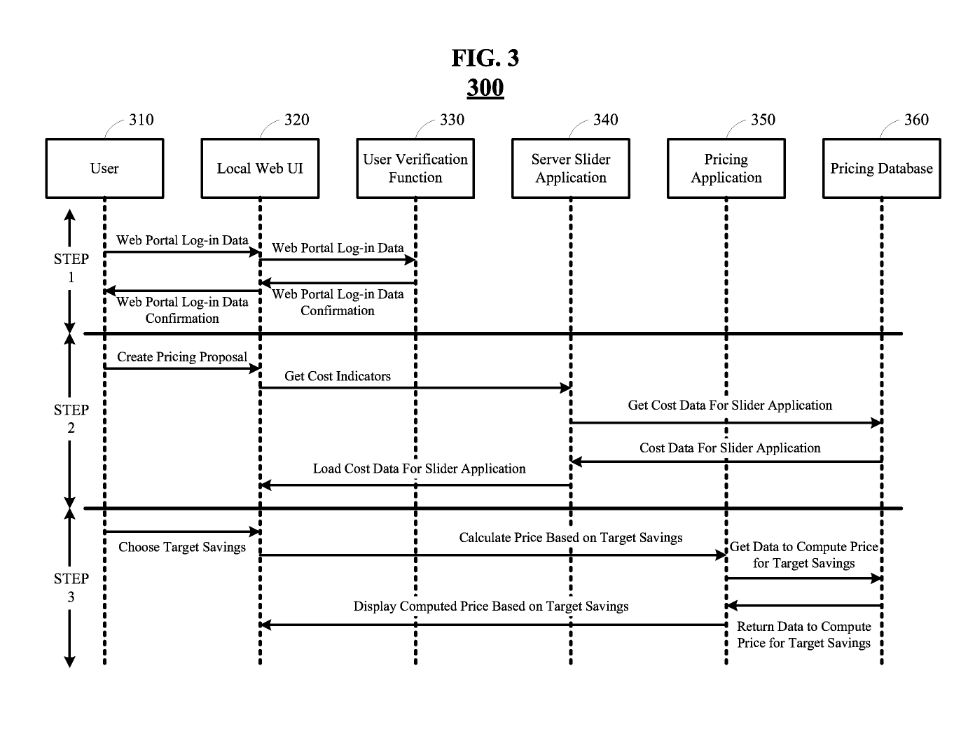

FIG. 3 illustrates an example of a messaging diagram according to an embodiment of the disclosure. The messaging diagram may be dissected into three separate steps representing three separate functions. Step 1 may address the function of system log-in and user verification. Step 2 may address the function of creating a price proposal slider application. Step 3 may address the function of using the price proposal slider application created in step 2.

Referring to step 1, a user 310 operating a local computer 110 or a portable mobile computing device 210 as described above enters and submits web portal log-in data via a local web user interface 320 such as the web page interface 125, 225. The web portal log-in data may comprise a log-in ID and a password but may also comprise any other form of uniquely identifiable information. A user verification function 330 within, for instance, the pricing slider application 165 operating on the pricing slider application server 160 may receive the web portal log-in data and verify it against a database of authorized users. Upon verification, the user verification function 330 may return a web portal log-in confirmation message to the user 310 via the local web user interface 320. The user 310 may now use the system.

Referring to step 2, the user 310 may create a pricing proposal for a particular service. The user 310 may enter details of the pricing proposal for multiple points of data such as, for instance, a number of units, a number of end users, a type of supplies, a type of service, a type of maintenance, a customer's current cost for the service, etc. using the local web user interface 320. The local web user interface 320 may be displaying a representation of the pricing slider application 165 on the local computer 110 or portable mobile computing device 210 for which the information entered by the user 310 is prompted. The local web user interface 320 by way of a server slider application 340 such as the pricing slider application 165 may then submit a request message to get cost indicators from a pricing database 360 such as pricing database 180. The cost data for the multiple points of data may then be returned to the server slider application 340. The server slider application 340 may then use the cost data to calculate several price points of interest including the customer's current cost for the service (input above), a street price, an authorization level, and a base cost. The server slider application 340 may then load the calculated price points into a graphical representation to be presented to the user 310 via the local web user interface 320.

Referring to step 3, the user 310 may now have a visual sliding scale of costs ranging from the base cost to provide the service up to the customer's current total cost. The user 310 may now input a target savings value via the local web user interface 320. This data may then be forwarded to a pricing application 350 so that a price may be calculated based on the target savings value. The pricing application 350 may then obtain any data needed to compute the price for the target savings from the pricing database 360. The pricing application may then display the computed price based on the target savings on the graphical representation presented to the user 310 via the local web user interface 320 in the form of a sliding icon or the like. Each time the user 310 moves the icon along the sliding scale to select a new target savings value, the process may be repeated to calculate a new price based on the new target savings value.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

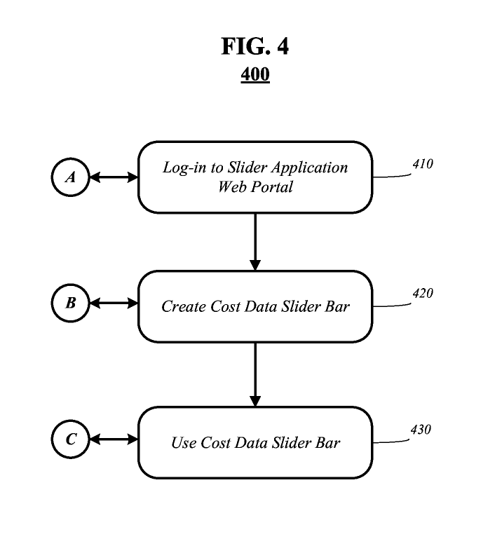

FIG. 4 illustrates an embodiment of a logic flow 400. The logic flow 400 may be representative of some or all of the operations executed by one or more embodiments described herein. The embodiments are not necessarily limited to the examples described herein. In the illustrated embodiment shown in FIG. 4, the logic flow 400 may create and use a cost slider bar for a given product or service or combination of product(s) or service(s). The processing may include verifying user account status before authorizing use of the system.

In the illustrated embodiment shown in FIG. 4, the logic flow 400 may log-in to a slider application web portal at block 410. For example, a user 105 may enter log-in data such as, for instance, a user ID and a password into the web page interface 125 of the browser application 120 on the local computer 110 via one or more peripheral input devices. The log-in data may be forwarded over the network 150 to the pricing slider application server 160 for verification.

In the illustrated embodiment shown in FIG. 4, the logic flow 400 may create a cost data slider bar at block 420. For example, the user 105 may create a pricing proposal based on multiple data points. The user 105 may enter details of the pricing proposal indicative of the multiple data points using the web page interface 125 of the browser application 120 on the local computer 110 via one or more peripheral input devices. The pricing proposal data may be forwarded over the network 150 to the pricing slider application 165 executing on the pricing slider application server 160 for processing. The pricing proposal data may then be used to calculate multiple price points on a graphical user interface. The graphical user interface may then be displayed to the user 105 via browser application 120 in the form of a cost data slider bar. The cost data slider bar may illustrate a sliding scale of the multiple relevant pricing points from base cost through the customer's current cost.

In the illustrated embodiment shown in FIG. 4, the logic flow 400 may use the cost data slider bar at block 430. For example, the user 105 may interact with the sliding scale graphical representation created at block 420 above. The user may input a target savings value (e.g., 15%). This value may be based on the customer's current total cost. The pricing slider application may receive the proposed cost savings target and calculate a new price for the proposal based on the desired target savings. The resulting new price may then be displayed on the cost data slider bar graphical representation.

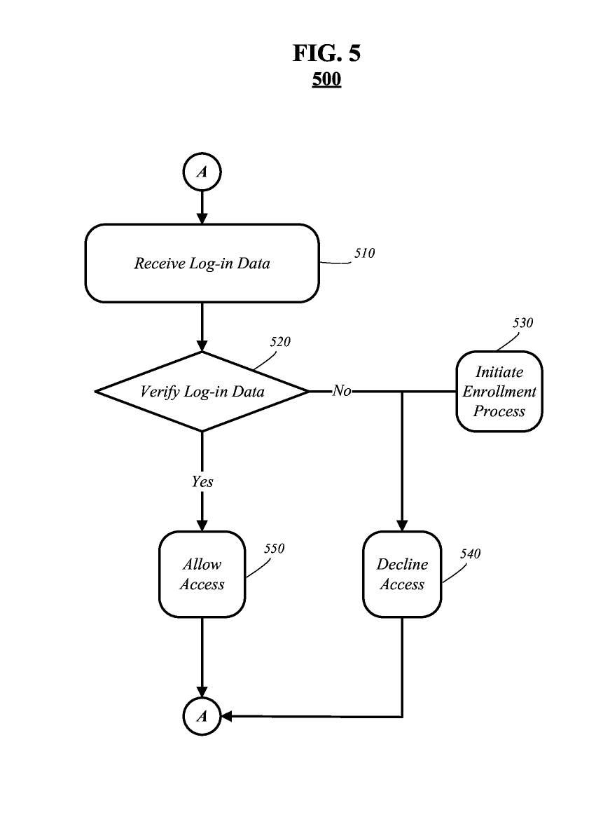

FIG. 5 illustrates an example embodiment of a logic flow 500. The logic flow 500 may be representative of some or all of the operations executed by one or more embodiments described herein. The embodiments are not necessarily limited to the examples described herein. In the illustrated embodiment shown in FIG. 5, the logic flow 500 may verify user account status before authorizing use of the system.

In the illustrated embodiment shown in FIG. 5, the logic flow 500 may receive log-in data at block 510. For example, a user 105 may enter log-in data such as, for instance, a user ID and a password into the web page interface 125 of the browser application 120 on the local computer 110 via one or more peripheral input devices. The log-in data may be forwarded over the network 150 to the pricing slider application 165 executing on the pricing slider application server 160 for verification. A verification module may process the received log-in data at block 520. The verification module may be part of the pricing slider application 165 operative to restrict access to only those users that have accounts established. The verification module may compare the received log-in data to a stored set of log-in data to determine a match. If no match is found, the pricing slider application 165 may decline access to the user 105 at block 540. When access is declined, the web page interface 125 shown by the browsing application 120 on local computer 110 may present a pop-up or dialog box with a message indicating that the log-in data supplied by the user 105 is invalid. The user 105 may be prompted to re-enter new log-in information or click on a link in the web page interface 125 that will launch an enrollment process at block 530.

If the original log-in data supplied by the user 105 is verified by the pricing slider application 165, the web page interface 125 of the browser application 120 on the local computer 110 may then present a home screen allowing the user to access and use the pricing slider application 165 at block 550.

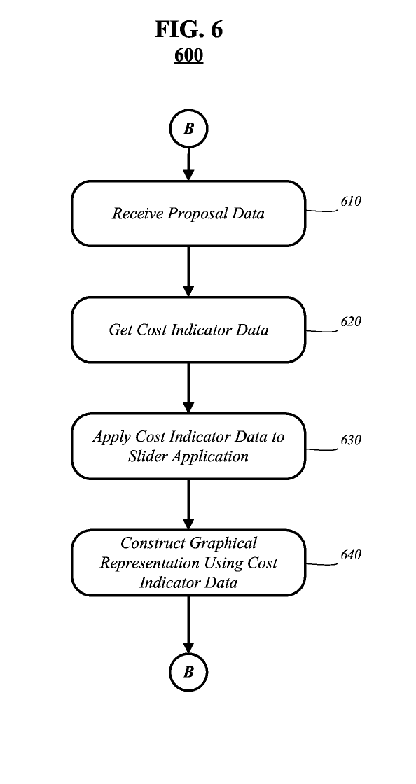

FIG. 6 illustrates an example embodiment of a logic flow 600. The logic flow 600 may be representative of some or all of the operations executed by one or more embodiments described herein. The embodiments are not necessarily limited to the examples described herein. In the illustrated embodiment shown in FIG. 6, the logic flow 600 may create a cost slider application.

In the illustrated embodiment shown in FIG. 6, the logic flow 600 may receive pricing proposal data at block 610. For example, a user may enter details of a pricing proposal indicative of the multiple data points using the web page interface 125 of the browser application 120 on the local computer 110 via one or more peripheral input devices. For a channel managed print services contract, the pricing proposal may include factors such as, for instance, the customer's current cost of service, a term of the contract (e.g., number of months), a number of printers subject to the contract, the type(s) of printers, an allotment of pages (e.g., impressions) per printer per month that may be printed, a maintenance service provision, etc. The pricing proposal data may be forwarded over the network 150 to the pricing slider application 165 executing on the pricing slider application server 160 for processing.

In the illustrated embodiment shown in FIG. 6, the logic flow 600 may get cost indicator data at block 620. For example, the pricing proposal data may then be used to calculate multiple price points on a graphical user interface. Each of the multiple data points may have a base cost associated with providing the service to which it refers. For example, 10 model printers may be priced at $20 per month for a 24 month contract while 10 model B color printers may be priced at $15 per month for a 24 month contract. The price may vary if the term of the contract is changed up (more months) or down (fewer months). Similarly, the cost per impression may be 2 cents for a model A printer and 3 cents for a model B printer. Thus, an allotment of 1000 impressions per month on a model A printer may be calculated as $20 per model A printer per month or $200 for 10 model A printers per month. A similar calculation may yield a cost of $30 per model B printer per month or $300 for 10 model B printers per month. This calculation would likely factor in the ink/toner supply usage. The cost to service 20 printers may be calculated as $50 per month and may also be factored into the base cost calculation of the contract. The pricing slider application 165 in conjunction with the pricing database server 170 and pricing database 180 may be operative to calculate and sum a cost for the pricing proposal based on the multiple data points entered by the user 105. In the example above, the base cost to fulfill a 24 month contract for 10 model A printers ($20/mo.) and 10 model B printers ($30/mo.) at an allotment of 1000 impressions per month for each printer ($500/mo.) with a maintenance provision ($50/mo.) may total $600 per month or a total cost of $14,400 for the length of the 24 month term.

Once a base cost for the pricing proposal has been calculated, other cost points may also be calculated. The base cost may be considered the lowest cost that can be charged without losing money on the contract. At the other end of the spectrum may be the customer's current cost. This is the cost that a customer is currently paying for the same or similar service. Any pricing proposal would likely need to be lower than this cost to entice the customer to switch service providers. In between the base cost and the customer's current cost may be other relevant cost points. One cost point may be considered a threshold authorization level. The authorization level cost is higher than the base cost as it builds in a minimum profit margin. To go below the minimum profit margin for a contract, the salesperson would need to obtain authorization from a higher ranking manager. The authorization level may be computed in any number of ways including, but not limited to, 1.x times the base cost where x represents the profit margin to be realized.

Another cost point may be characterized as the street price. The street price may reflect the cost of a similar offering that may be made by a competitor. The street price gives the salesperson an indication of the price they would need to beat given a customer that seeks other offers. The street price may be calculated or estimated based on internal research or other methods.

The example above is purely illustrative. Many additional data points may be factored into a pricing proposal to determine a base cost. The example above should not be considered limiting.

In the illustrated embodiment shown in FIG. 6, the logic flow 600 may apply cost indicator data to a slider application at block 630. For example, once the base cost has been calculated from the raw data points in the pricing proposal, the authorization level cost, the street price, and the customer's total current cost (likely part of the pricing proposal data) may be obtained and applied by the pricing slider application 165 to create a graphical representation for the salesperson.

In the illustrated embodiment shown in FIG. 6, the logic flow 600 may construct a cost slider graphical representation using the cost indicator data at block 640. For example, the graphical user interface created by the pricing slider application 165 may comprise an interactive bar graph with visual indicators of multiple cost points. The cost points may include a base cost, an authorization level cost, a street price, and the customer's current cost. The cost slider graphical representation may then be presented in the form of a cost data slider bar to the user 105 via the web page interface 125 of browser application 120 on local computer 110. The cost data slider bar may illustrate a sliding scale of the multiple relevant pricing points from base cost through the customer's current cost.

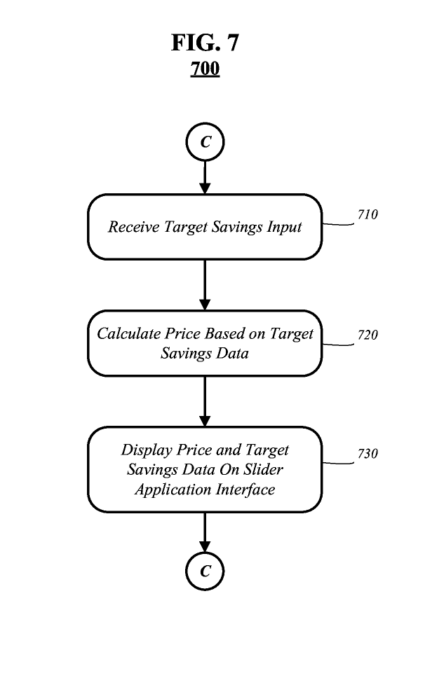

FIG. 7 illustrates an example embodiment of a logic flow 700. The logic flow 700 may be representative of some or all of the operations executed by one or more embodiments described herein. The embodiments are not necessarily limited to the examples described herein. In the illustrated embodiment shown in FIG. 7, the logic flow 700 may create a cost slider application.

In the illustrated embodiment shown in FIG. 7, the logic flow 700 may receive a target savings input at block 710. For example, a user 105 (e.g., salesperson) may input a specific target savings percentage using the web page interface 125 of the browser application 120 on the local computer 110 via one or more peripheral input devices. The web page interface 125 may be illustrating the graphical representation in the form of a cost data slider bar. The cost data slider bar may illustrate each of the multiple relevant pricing points from base cost through the customer's current cost on a sliding scale. The web page interface 125 may also include a place for the user 105 to enter a target savings percentage as calculated from the customer's current cost. Alternatively or in addition, the web page interface may include a place for the user 105 to enter a target price for the contract. The entered data may then be forwarded to the pricing slider application 165 over network 150.

In the illustrated embodiment shown in FIG. 7, the logic flow 700 may calculate a price and/or a target savings at block 720. For example, the user 105 may enter a target savings percentage at block 710 above. In this instance, the pricing slider application 165 will calculate the price associated with the targeted savings percentage. Alternatively, the user 105 may enter a desired price at block 710 above. In this instance, the pricing slider application 165 will calculate the percentage savings associated with the desired price.

In the illustrated embodiment shown in FIG. 7, the logic flow 700 may display the price and target savings data at block 730. For example, once the price and target savings data has been calculated in block 720 using the input data from block 710, the pricing slider application 165 can map the results onto the graphical representation of the cost slider bar. This price point may be characterized as the target savings cost. Moreover, the target savings cost may include an icon that may be dragged left or right to cause the pricing slider application 165 to interpret the movement as new input and to re-calculate the target savings percentage and pricing data.

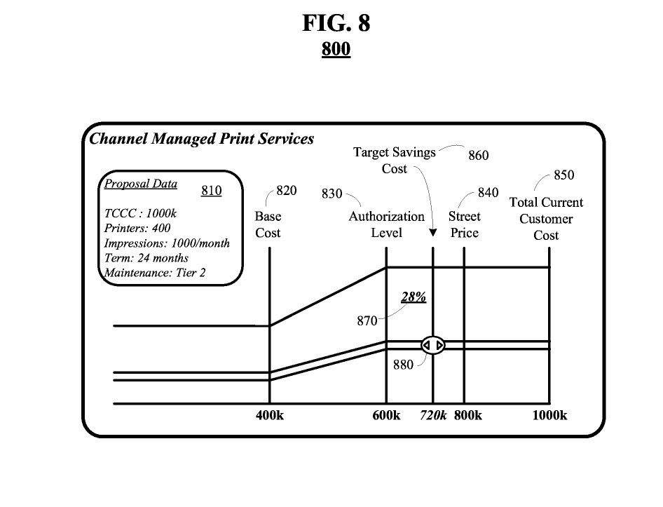

FIG. 8 illustrates an example of a pricing slider application screenshot 800 according to an embodiment of the disclosure. In this example, the screenshot 800 has been labeled “Channel Managed Print Services” to indicate that the pricing data shown references a channel managed print services contract. In one portion of the screenshot 800 is a section pertaining to pricing proposal data 810. The pricing proposal data 810 may include the multiple data points upon which the pricing data has been calculated. For example, the pricing proposal data 810 illustrates multiple data points that indicate a total current customer cost (TCCC) of 1000 k, 400 printers, 100 impressions per printer per month, a 24 month term for the contract, and a tier 2 maintenance contract. Each of these data points may be used to calculate the various pricing points for the graphical representation shown in the screenshot 800. The screenshot 800 illustrates five (5) price points. The price points include the base cost 820, an authorization level 830, a street price 840, a total current customer cost 850, and a target savings cost 860. A slider icon 880 is associated with the target savings cost 860 price point and a portion of the screen that identifies the savings percentage 870 are also part of the screenshot 800.

Each price point (820, 830, 840, 850, 860) may be displayed as a line or bar on the graphical representation. At the point where the price point line intersects the x-axis of the graph, a numerical price value indicates the price value for that particular pricing point. In this example, the base cost is 400 k, the authorization level is 600 k, the street price is 800 k, and the TCCC is 1000 k. The base cost 820 may be calculated by factoring the cost for each of the multiple points of data in the pricing proposal 810 and summing to obtain the minimum cost necessary to provide the service(s). The authorization level may be obtained by multiplying the base cost 820 by a profit margin factor (e.g. 1.5 in this example). The authorization level 830 sets a minimum price that a salesperson may enter a contract without obtain approval from higher management. The street price 840 may be an estimate or calculation based on research of competitor pricing given the multiple data points in the pricing proposal 810. The TCCC 850 may have already been obtained from the customer and included in the pricing proposal 810.

The authorization level 830 may represent a bright line cut-off and the graphical representation may utilize color or highlighting to provide a strong visual indicator. The area to the left of the authorization level 830 may be presented in red to indicate that a contract price in this area is likely not a good idea and would require management approval. The area to the right of the authorization level 830 may be presented in various shades of green to indicate the level of profit for a contract price. Areas closer to the authorization level 830 may be lighter green to indicate less profit while areas closer to the TCCC 850 may be shaded darker green to indicate higher profit. The embodiments are not limited to these examples as other visual cues may be employed to the same effect.

To use the slider application 165 underlying the illustrated screenshot 800 once the pricing points have been calculated and displayed, the user 105 may move a cursor to the icon 880 and drag it left and right along the sliding spectrum of price points. Once the cursor is released, the pricing slider application 165 may calculate a total price and corresponding percentage of savings for that price point along the slider. Thus, if the user 105 wants a 28% target savings, the cursor may be moved until the target savings indicator 870 reads “28%”. The pricing slider application 165 may then calculate and graphically display the price point line and a price value based on the location along the slider bar.

In using the system, a user 105 need only supply the raw multiple data points to allow the pricing slider application 165 to calculate and display relevant price points in an interactive graphical manner. The user may then slide an icon 880 along the slider bar to quickly and efficiently determine whether a particular targeted savings rate is achievable for a contract. In addition, the slider bar can quickly impart to the user 105 whether the target savings rate is even feasible (e.g., above the base cost), requires authorization (e.g., falls below a threshold profit margin), and beats a competitor's similar offer (e.g., less than a street price). The heavy computation is shifted from the salesperson to the system. Thus, the salesperson is relieved from knowing how to calculate a base price from the set of multiple data points which can be complex and prone to error.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system comprising:
a server including a processing component, the server to host and manage:
an application operative to:
receive multiple data points from a client computer device over a network connection, the multiple data points comprising pricing proposal data for a service to be provided;
determine multiple pricing points, the multiple pricing points including a base cost pricing point, the base cost pricing point calculated from the multiple data points and indicative of the minimum cost to provide the service; and
create an interactive graphical representation of the multiple pricing points;
receive input from the client computer device indicative of a target cost savings; and
calculate a target savings pricing point to be illustrated on the graphical representation of the multiple pricing points.

2. The system of claim 1, the application further operative to forward the interactive graphical representation of the multiple pricing points to the client computer device over the network connection wherein the client computer device displays the interactive graphical representation of the multiple pricing points.

3. The system of claim 2, the interactive graphical representation of the multiple pricing points comprising a cost data slider bar, the cost data slider bar including an icon movable between the multiple pricing points wherein icon movement causes the application to re-calculate the target savings pricing point.

4. The system of claim 3, the pricing points including an authorization level pricing point, the authorization level pricing point being greater than the base cost and indicative of a cost, below which, authorization to engage in a contract is required.

5. The system of claim 4, the pricing points including a street price point indicative of a cost that a competitor could provide the same or a similar service, and a total current customer cost (TCCC) indicative of a cost the customer is currently paying for the same or a similar service.

6. The system of claim 3, the client computer device executing a browser application that displays the interactive graphical representation of the multiple pricing points and permits the movement of the icon.

7. The system of claim 1, the client computer device comprising a portable mobile computing device.

8. The system of claim 5, the area on the interactive graphical representation between the base cost pricing point and the authorization level pricing point being highlighted in a first color and the area on the interactive graphical representation between the authorization level pricing point and the TCCC pricing point being highlighted in a first color.

9. A computer-implemented method, comprising:
receiving multiple data points from a client computer device over a network connection, the multiple data points comprising pricing proposal data for a service to be provided;
determining multiple pricing points, the multiple pricing points including a base cost pricing point, the base cost pricing point calculated from the multiple data points and indicative of the minimum cost to provide the service; and
creating an interactive graphical representation of the multiple pricing points;
receiving input from the client computer device indicative of a target cost savings; and
calculating a target savings pricing point to be illustrated on the graphical representation of the multiple pricing points.

10. The computer-implemented method of claim 9, the interactive graphical representation of the multiple pricing points comprising a cost data slider bar, the cost data slider bar including an icon movable between the multiple pricing points wherein icon movement causes the application to re-calculate the target savings pricing point.

11. The computer-implemented method of claim 10, the pricing points including an authorization level pricing point, the authorization level pricing point being greater than the base cost and indicative of a cost, below which, authorization to engage in a contract is required.

12. The computer-implemented method of claim 11, the pricing points including a street price point indicative of a cost that a competitor could provide the same or a similar service, and a total current customer cost (TCCC) indicative of a cost the customer is currently paying for the same or a similar service.

13. The computer-implemented method of claim 9, the client computer device comprising a portable mobile computing device.

14. The computer-implemented method of claim 12, the area on the interactive graphical representation between the base cost pricing point and the authorization level pricing point being highlighted in a first color and the area on the interactive graphical representation between the authorization level pricing point and the TCCC pricing point being highlighted in a first color.

15. A tangible computer-readable storage medium comprising instructions that, when executed, cause a system to:
receive multiple data points from a client computer device over a network connection, the multiple data points comprising pricing proposal data for a service to be provided;
determine multiple pricing points, the multiple pricing points including a base cost pricing point, the base cost pricing point calculated from the multiple data points and indicative of the minimum cost to provide the service; and
create an interactive graphical representation of the multiple pricing points;
receive input from the client computer device indicative of a target cost savings; and
calculate a target savings pricing point to be illustrated on the graphical representation of the multiple pricing points so as to indicate visually the cost savings to be realized when compared to the multiple pricing points.

16. The tangible computer-readable storage medium of claim 15, the interactive graphical representation of the multiple pricing points comprising a cost data slider bar, the cost data slider bar including an icon movable between the multiple pricing points wherein icon movement causes the application to re-calculate the target savings pricing point.

17. The tangible computer-readable storage medium of claim 16, the pricing points including an authorization level pricing point, the authorization level pricing point being greater than the base cost and indicative of a cost, below which, authorization to engage in a contract is required.

18. The tangible computer-readable storage medium of claim 17, the pricing points including a street price point indicative of a cost that a competitor could provide the same or a similar service, and a total current customer cost (TCCC) indicative of a cost the customer is currently paying for the same or a similar service.

19. The tangible computer-readable storage medium of claim 15, the client computer device comprising a portable mobile computing device.

20. The tangible computer-readable storage medium of claim 18, the area on the interactive graphical representation between the base cost pricing point and the authorization level pricing point being highlighted in a first color and the area on the interactive graphical representation between the authorization level pricing point and the TCCC pricing point being highlighted in a first color.
